(19) United States
(12) Patent Application Publication
(10) Pub. No.: US 2026/0190055 A1
(43) Pub. Date: Jul. 2, 2026

(54) PHYSICAL CELL IDENTITY

(71) Applicant: QUALCOMM Incorporated, San Diego, CA (US)

(72) Inventors: Navid ABEDINI, Basking Ridge, NJ (US); Xiaoxia ZHANG, San Diego, CA (US); Tao LUO, San Diego, CA (US); Junyi LI, Greentown, PA (US); Peter GAAL, San Diego, CA (US)

(21) Appl. No.: 19/382,329

(22) Filed: Nov. 7, 2025

Related U.S. Application Data
(60) Provisional application No. 63/739,401, filed on Dec. 27, 2024.

(51) Int. Cl. H04W 56/00; H04L 27/26; H04W 24/10; H04W 74/0833

(52) U.S. Cl. CPC H04W 56/002; H04L 27/26025; H04W 24/10; H04W 74/0833

(57) ABSTRACT

Various aspects of the present disclosure generally relate to wireless communication. Some aspects more specifically relate to reducing a total quantity of all possible physical cell identities (PCIs) to a total quantity of a subset of the possible PCIs. The subset of possible PCIs may be referred to as valid PCIs. For example, the cell search procedure may be constrained to fewer than 1008 valid PCIs. In some examples, a user equipment may identify the valid PCIs in accordance with a wireless communications standard or signaling from the cell.

### CROSS-REFERENCE TO RELATED APPLICATION

This Patent Application claims priority to U.S. Provisional Ser. No. 63/739,401, filed on Dec. 27, 2024, entitled “PHYSICAL CELL IDENTITY,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with physical cell identity design.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples.

During a cell search procedure, a user equipment (UE) may blindly scan for a synchronization signal block (SSB), which helps the UE to synchronize with a network node that transmitted the SSB. The SSB may include a primary synchronization signal (PSS), a secondary synchronization signal (SSS), and a physical broadcast channel (PBCH). Upon detecting the SSB, the UE may calculate a physical cell identity (PCI) of the network node using the PSS and SSS. The PCI identifies a cell of the network node that transmitted the SSB. In some examples, the PCI may have a large quantity of possible values, such as 1008. Such a large quantity may cause the UE to dedicate excessive resources (for example, hardware resources, processing resources, or battery resources, among other examples) to the cell search procedure.

### SUMMARY

Some aspects described herein relate to an apparatus for wireless communication at a user equipment (UE). The apparatus may include one or more memories storing processor-executable code and one or more processors coupled with the one or more memories. At least one processor of the one or more processors may be configured to cause the UE to receive a synchronization signal block (SSB) that indicates a physical cell identity (PCI) of a subset of valid PCIs of a set of PCIs, the subset of valid PCIs corresponding to a cell search space that is reduced compared to a cell search space corresponding to the set of PCIs. At least one processor of the one or more processors may be configured to cause the UE to communicate one or more wireless communications in accordance with the PCI.

Some aspects described herein relate to an apparatus for wireless communication at a network node. The apparatus may include one or more memories storing processor-executable code and one or more processors coupled with the one or more memories. At least one processor of the one or more processors may be configured to cause the network node to transmit an SSB that indicates a PCI of a subset of valid PCIs of a set of PCIs, the subset of valid PCIs corresponding to a cell search space that is reduced compared to a cell search space corresponding to the set of PCIs. At least one processor of the one or more processors may be configured to cause the network node to communicate one or more wireless communications in accordance with the PCI.

Some aspects described herein relate to a method of wireless communication performed at a UE. The method may include receiving an SSB that indicates a PCI of a subset of valid PCIs of a set of PCIs, the subset of valid PCIs corresponding to a cell search space that is reduced compared to a cell search space corresponding to the set of PCIs. The method may include communicating one or more wireless communications in accordance with the PCI.

Some aspects described herein relate to a method of wireless communication performed at a network node. The method may include transmitting an SSB that indicates a PCI of a subset of valid PCIs of a set of PCIs, the subset of valid PCIs corresponding to a cell search space that is reduced compared to a cell search space corresponding to the set of PCIs. The method may include communicating one or more wireless communications in accordance with the PCI.

Some aspects described herein relate to an apparatus for wireless communication. The apparatus may include means for receiving an SSB that indicates a PCI of a subset of valid PCIs of a set of PCIs, the subset of valid PCIs corresponding to a cell search space that is reduced compared to a cell search space corresponding to the set of PCIs. The apparatus may include means for communicating one or more wireless communications in accordance with the PCI.

Some aspects described herein relate to an apparatus for wireless communication. The apparatus may include means for transmitting an SSB that indicates a PCI of a subset of valid PCIs of a set of PCIs, the subset of valid PCIs corresponding to a cell search space that is reduced compared to a cell search space corresponding to the set of PCIs. The apparatus may include means for communicating one or more wireless communications in accordance with the PCI.

Some aspects described herein relate to a non-transitory computer-readable medium storing a set of instructions for wireless communication. The set of instructions may include one or more instructions that, when executed at a UE, cause the UE to receive an SSB that indicates a PCI of a subset of valid PCIs of a set of PCIs, the subset of valid PCIs corresponding to a cell search space that is reduced compared to a cell search space corresponding to the set of PCIs. The set of instructions may include one or more instructions that, when executed at the UE, cause the UE to communicate one or more wireless communications in accordance with the PCI.

Some aspects described herein relate to a non-transitory computer-readable medium storing a set of instructions for wireless communication. The set of instructions may include one or more instructions that, when executed at a network node, cause the network node to transmit an SSB that indicates a PCI of a subset of valid PCIs of a set of PCIs, the subset of valid PCIs corresponding to a cell search space that is reduced compared to a cell search space corresponding to the set of PCIs. The set of instructions may include one or more instructions that, when executed at the network node, cause the network node to communicate one or more wireless communications in accordance with the PCI.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network.

FIG. 2 is a diagram illustrating an example associated with signaling for physical cell identity (PCI) design.

FIG. 3 is a flowchart illustrating an example process performed, for example, at a user equipment (UE) or an apparatus of a UE that supports PCI design.

FIG. 4 is a flowchart illustrating an example process performed, for example, at a network node or an apparatus of a network node that supports PCI design.

FIG. 5 is a diagram of an example apparatus of a UE for wireless communication that supports PCI design.

FIG. 6 is a diagram of an example apparatus of a network node for wireless communication that supports PCI design.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

During a cell search procedure, a user equipment (UE) may identify a physical cell identity (PCI) of a cell from a primary synchronization signal (PSS) and a secondary synchronization signal (SSS) in a synchronization signal block (SSB) transmitted by the cell. In some examples, the quantity of possible PCIs may be large. For example, a PSS may have 3 possible values, and an SSS may have 336 possible values, resulting in 1008 possible PCIs. However, many scenarios may not require all possible PCIs, and allowing for all possible PCIs can involve excessive hardware, processing, and/or battery resources at the UE due to searching and/or measurement of all possible PCIs.

Various aspects relate generally to PCI design. Some aspects more specifically relate to reducing a total quantity of all possible PCIs to a total quantity of a subset of the possible PCIs. The subset of possible PCIs may be referred to as valid PCIs. For example, the cell search procedure may be constrained to fewer than 1008 valid PCIs. As a result, a search space of the cell search procedure may be reduced in accordance with the subset of possible PCIs. In some examples, the UE may identify the valid PCIs in accordance with a wireless communications standard or signaling from the cell.

In some aspects, one or more bits of the PCI and/or PSS may indicate information other than cell identifier information. For example, the information may be whether the cell supports a given functionality or has a given attribute. In some examples, the information may be indicated by an X most significant bits or a Y least significant bits of the PCI. Additionally or alternatively, the PSS may indicate the information.

Particular aspects of the subject matter described in this disclosure can be implemented to realize one or more of the following potential advantages. In some examples, the described techniques can be used to reduce hardware and/or processing resource utilization at the UE. For example, reducing the search space of the cell search procedure in accordance with the subset of possible PCIs may help to simplify searching and/or measurement at the UE. For example, the UE may perform the cell search procedure in accordance with the reduced search space instead of a larger search space.

Using one or more bits of the PCI and/or PSS to indicate information other than cell identifier information may help to reduce signaling overhead. For example, the other information may be conveyed with the SSB instead of in dedicated signaling, which may help to reduce a quantity of time resources and/or frequency resources occupied by the other information.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

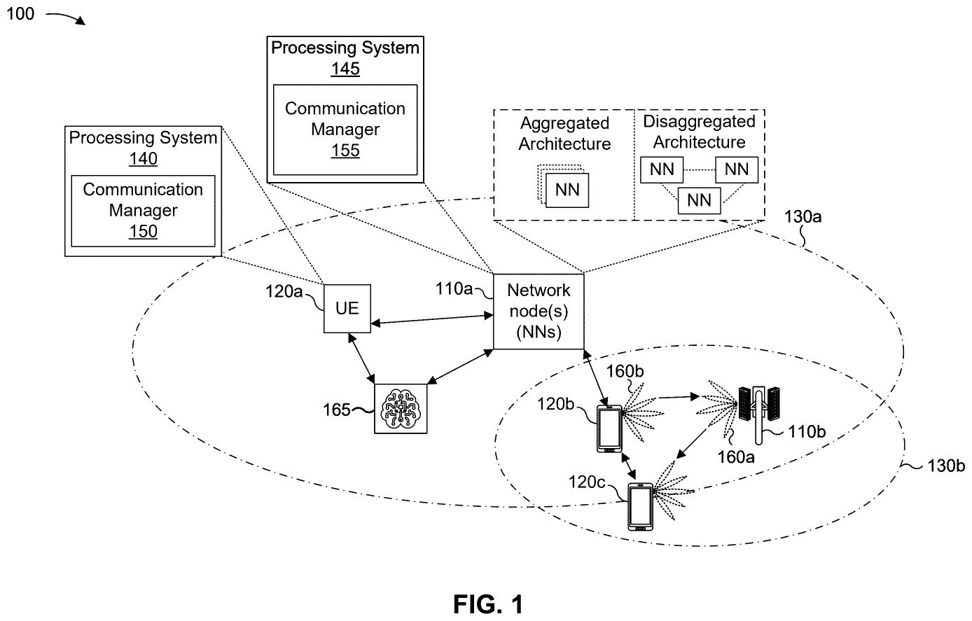

FIG. 1 is a diagram illustrating an example of a wireless communication network 100. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot formal indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, one or more network nodes 110, one or more UEs 120, and/or one or more servers, and/or one or more components of a cloud computing network, among other examples). For example, in an deployment where AI/ML functionality is performed independently at a device 165, sometimes referred to as “overlay AI/ML”, the AI/ML model (or an instance or portion of the AI/ML model) may be deployed at a UE 120 (for example, at the processing system 140), a network node 110 (for example, at the processing system 145), one or more servers, and/or one or more components of a cloud computing network, among other examples. Additionally or alternatively, in a deployment where AI/ML functionality is coordinated between different devices 165, sometimes referred to as “coordinated AI/ML”, or performed at all device and network layers, sometimes referred to as “native AI/ML”, the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML and/or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, and/or efficient use of network bandwidth, and/or to reduce latency, among other examples). For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases such as a self-organizing network (SON), minimization of drive test (MDT), quality of experience (QoE), positioning, sensing, predictive mobility, and/or traffic prediction, among other examples. In some examples, AI-as-a-Service use cases may include measurement collection reporting by a UE 120, device selection criteria (for example, according to a geographical area where measurements are to be collected and/or UE capabilities to be used to collected measurements), and/or reporting configurations (for example, reporting parameters such as location, time, and/or sensor information, among other examples). Additionally or alternatively, the AI/ML model(s) may enable AI/ML procedures (for example, RAN-triggered service establishment, configuration, inferencing using UE-side and/or network-side models, performance monitoring and/or management, and/or capability signaling, among other examples). Additionally or alternatively, the AI/ML model(s) may enable RAN-based AI/ML services via one or more application program interfaces (APIs) and/or management interfaces for use cases such as beam management, radio resource monitoring (RRM) relaxation, mobility prediction, load prediction, network energy savings, and/or coverage and capacity improvements, among other examples).

In some aspects, the UE 120 may include a communication manager 150. As described in more detail elsewhere herein, the communication manager 150 may receive an SSB that indicates a PCI of a subset of valid PCIs of a set of PCIs, the subset of valid PCIs corresponding to a cell search space that is reduced compared to a cell search space corresponding to the set of PCIs; and communicate one or more wireless communications in accordance with the PCI. Additionally or alternatively, the communication manager 150 may perform one or more other operations described herein.

In some aspects, the network node 110 may include a communication manager 155. As described in more detail elsewhere herein, the communication manager 155 may transmit an SSB that indicates a PCI of a subset of valid PCIs of a set of PCIs, the subset of valid PCIs corresponding to a cell search space that is reduced compared to a cell search space corresponding to the set of PCIs; and communicate one or more wireless communications in accordance with the PCI. Additionally or alternatively, the communication manager 155 may perform one or more other operations described herein.

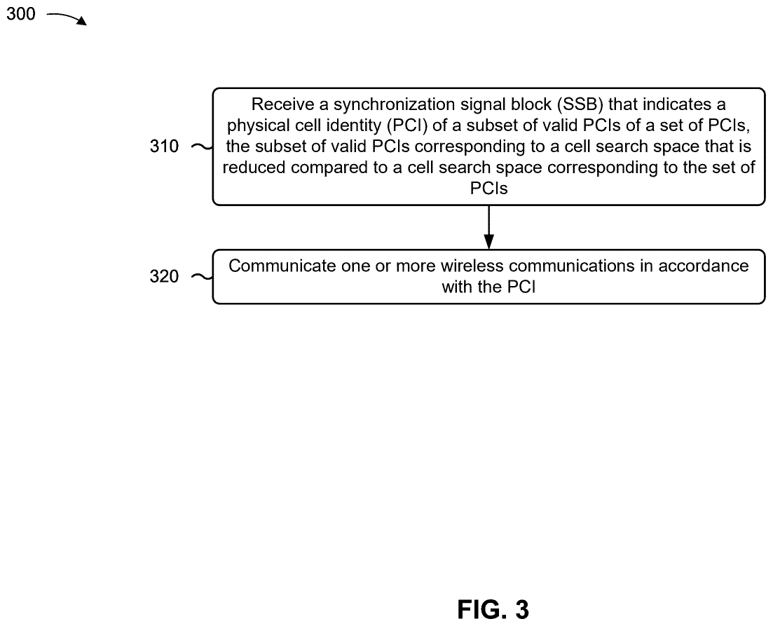

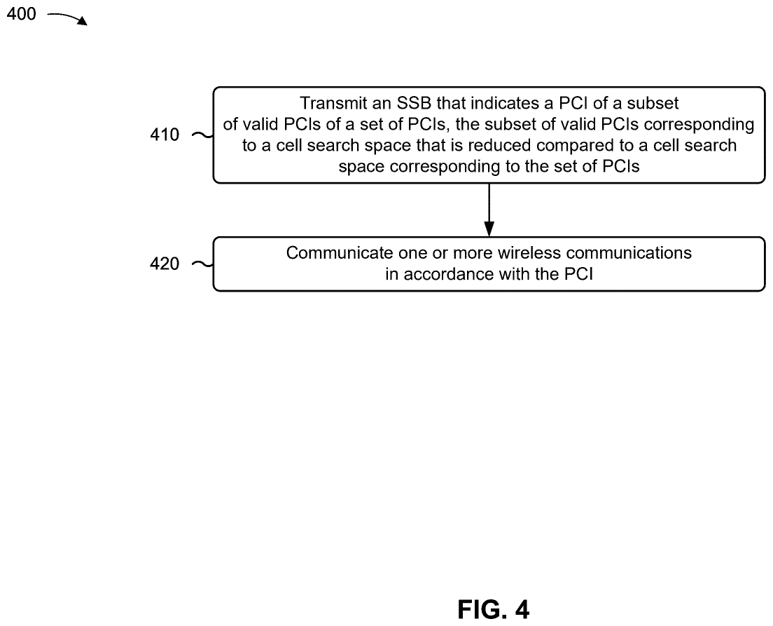

The network node 110, the processing system 145 of the network node 110, the UE 120, the processing system 140 of the UE 120, a CU, a DU, an RU, or any other component(s) of FIG. 1 may implement one or more techniques or perform one or more operations associated with PCI design, as described in more detail elsewhere herein. For example, the processing system 145 of the network node 110, the processing system 140 of the UE 120, a CU, a DU, and/or an RU may perform or direct operations of, for example, process 300 of FIG. 3, process 400 of FIG. 4, or other processes as described herein (alone or in conjunction with one or more other processors). Memory of the network node 110 may store data and program code (or instructions) for the network node 110, the CU, the DU, or the RU. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, a CU, a DU, and/or an RU, may cause the one or more processors to perform process 300 of FIG. 3, process 400 of FIG. 4, or other processes as described herein. In some examples, executing instructions may include running the instructions, converting the instructions, compiling the instructions, and/or interpreting the instructions, among other examples.

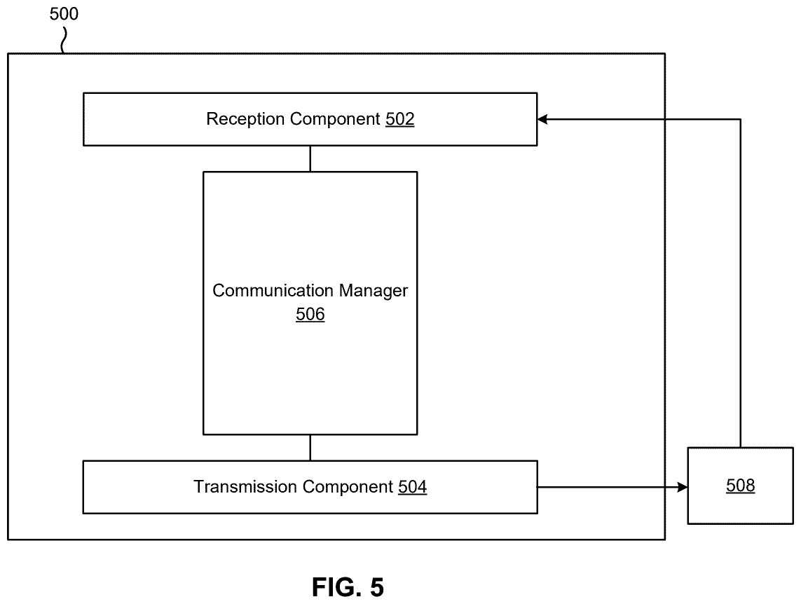

In some aspects, the UE 120 includes means for receiving an SSB that indicates a PCI of a subset of valid PCIs of a set of PCIs, the subset of valid PCIs corresponding to a cell search space that is reduced compared to a cell search space corresponding to the set of PCIs; and/or means for communicating one or more wireless communications in accordance with the PCI. The means for the UE 120 to perform operations described herein may include, for example, one or more of communication manager 150, processing system 140, a radio, one or more RF chains, one or more transceivers, one or more antennas, one or more modems, a reception component (for example, reception component 502 depicted and described in connection with FIG. 5), and/or a transmission component (for example, transmission component 504 depicted and described in connection with FIG. 5), among other examples.

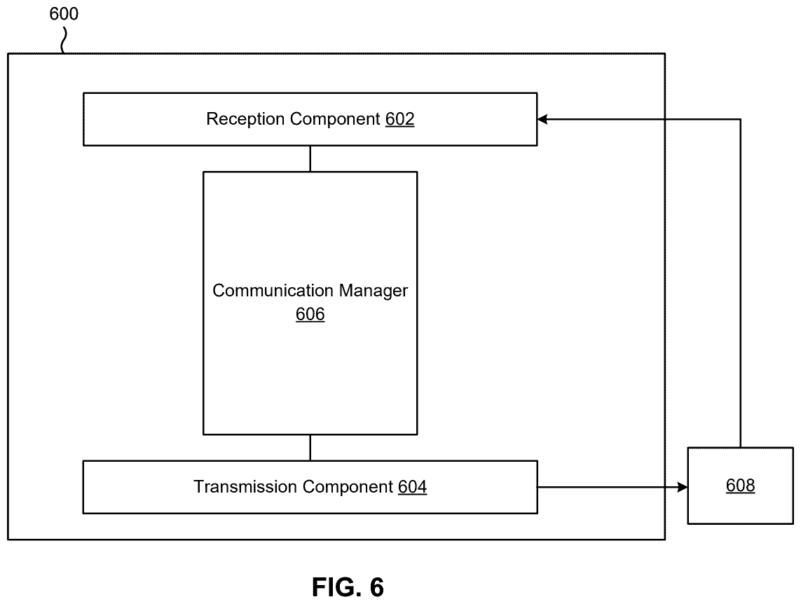

In some aspects, the network node 110 includes means for transmitting an SSB that indicates a PCI of a subset of valid PCIs of a set of PCIs, the subset of valid PCIs corresponding to a cell search space that is reduced compared to a cell search space corresponding to the set of PCIs; and/or means for communicating one or more wireless communications in accordance with the PCI. The means for the network node 110 to perform operations described herein may include, for example, one or more of communication manager 155, processing system 145, a radio, one or more RF chains, one or more transceivers, one or more antennas, one or more modems, a reception component (for example, reception component 602 depicted and described in connection with FIG. 6), and/or a transmission component (for example, transmission component 604 depicted and described in connection with FIG. 6), among other examples.

The SSB may carry various types of information, such as information outside of master information block (MIB) content. For example, in cases where a discovery reference signal (DRS) includes one or more of the PSS or the SSS, the SSB may convey certain timing information via the DRS, such as a location of a full SSB burst or a location of an uplink wake-up signal (UL-WUS) for an on-demand SSB (OD-SSB). In the context of multi-radio spectrum sharing (MRSS), the SSB may indicate whether a PSS or an SSS is a 6G PSS or SSS, or a 5G PSS or SSS. Additionally, or alternatively, the SSB may indicate PBCH frequency domain resource information, which may enable flexible placement of the PBCH in the frequency domain. In some examples, the SSB may differentiate terrestrial network (TN) and NTN cells operating on the same frequency. Before transmission of the MIB, the SSB may indicate barring information; in examples involving dynamic MIB content, the SSB may supply information regarding a version identification or change in MIB content. Additionally, or alternatively, the SSB may convey information for extending a pool of cell identifiers to support dense or mobile networks. This information may be carried via the SSB by extending a pool of sequences for PSS, SSS, or DMRS; based at least in part on an order of symbols (e.g., PSS followed by SSS or SSS followed by PSS); using a tone selection of the DMRS; by adding a third sequence (e.g., a short sequence) that is frequency-division-multiplexed or time-division-multiplexed with the PSS or the SSS; or in a phase of the SSS sequence (e.g., and relying on the PSS for channel estimation).

During a cell search procedure, the UE 120 may identify a PCI of a cell from a PSS and an SSS in an SSB transmitted by the cell. In some examples, the quantity of possible PCIs may be large. For example, a PSS may have 3 possible values, and an SSS may have 336 possible values, resulting in 1008 possible PCIs. However, many scenarios may not require all possible PCIs, and allowing for all possible PCIs can involve excessive hardware, processing, or battery resources at the UE 120 due to searching or measurement of all possible PCIs.

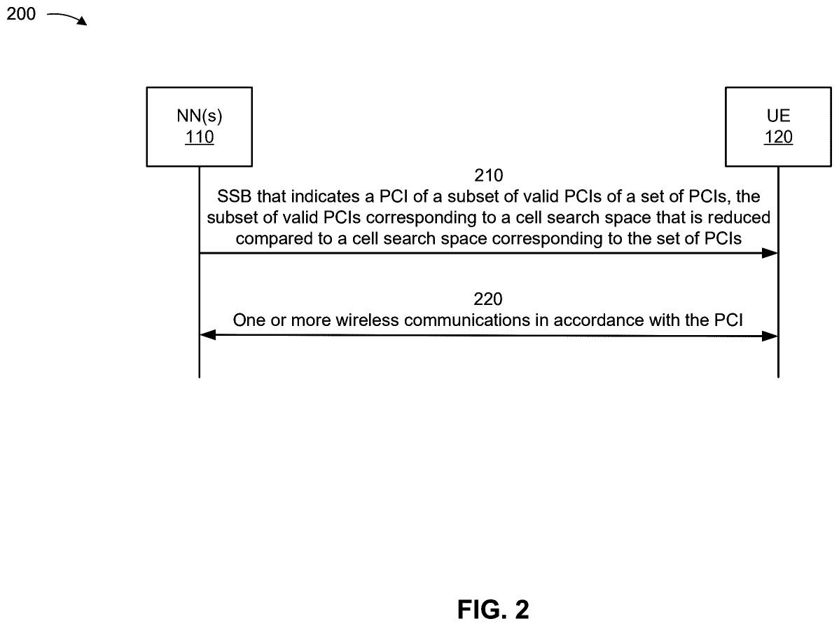

FIG. 2 is a diagram illustrating an example 200 associated with signaling for PCI design. As shown in FIG. 2, a network node 110 and a UE 120 may communicate with one another.

As shown by reference number 210, the network node 110 may transmit, and the UE 120 may receive, an SSB that indicates a PCI of a subset of valid PCIs of a set of PCIs. The set of PCIs may be all possible PCIs (e.g., 1008 PCIs). The SSB may indicate the PCI in that the SSB may include one or more signals, such as a PSS or an SSS, that the UE 120 may use to calculate the PCI. The valid PCIs may be valid for a given scenario (e.g., for specific operators, specific areas, specific frequencies, specific time periods, or the like). The subset of valid PCIs may be include fewer total PCIs than the set of PCIs includes. For example, the set of PCIs may include valid PCIs for the given scenario and invalid PCIs for the given scenario. In some aspects, the subset of valid PCIs may be associated with a single PSS. The subset of valid PCIs may be associated with a single PSS in that each PCI may correspond to the same PSS. For example, in low frequency bands, the PSS may have one hypothesis (e.g., corresponding to one candidate for the PSS). In some aspects, the subset of valid PCIs may correspond to a cell search space that is reduced compared to a cell search space corresponding to the set of PCIs. A cell search space may define one or more cells for which the UE 120 is to scan during a cell search procedure. A set or subset of PCIs may correspond to a cell search space in that a size of the cell search space may depend on the set or subset of PCIs. The valid PCIs being a subset of the set of PCIs may help to reduce hardware or processing resource utilization at the UE 120. For example, reducing the search space of the cell search procedure in accordance with the subset of possible PCIs may help to simplify searching or measurement at the UE 120. For example, the UE 120 may perform the cell search procedure in accordance with the reduced search space instead of a larger search space.

In some aspects, the PCI may be associated with first information related to an identity of a cell and second information that is different than the first information. For example, the first information may indicate the identity of the cell, and the second information may indicate non-cell-identifying information, such as whether or not the cell supports a given functionality or attribute. The PCI may be associated with information in that the PCI, or one or more indications of the PCI (e.g., the PSS or the SSS), may indicate the information. For example, one or more bits of the PCI or indication(s) may be repurposed to carry non-cell-identifying information. The one or more bits may be selected with proper PCI planning (e.g., so as to avoid PCI collisions or conflicts). In some aspects, the second information may be indicated by one or more most significant bits or one or more least significant bits of the PCI. For example, the X most significant bits or the X least significant bits of the PCI (as encoded by the SSB) may indicate whether or not the cell supports the given functionality or attribute. In some aspects, the second information may be indicated by a PSS associated with the PCI. The PSS may be associated with the PCI in that the PCI may be derived, at least in part, using the PSS. For example, the choice of PSS (e.g., PSS identifier) may carry the second information. The PCI being associated with the first information and the second information may help to reduce signaling overhead. For example, the other information may be conveyed with the SSB instead of in dedicated signaling, which may help to reduce a quantity of time resources or frequency resources occupied by the other information.

In some examples, the PCI design may be configured by the network node 110 or predefined in a wireless communication standard. For example, the subset of valid PCIs (e.g., a reduced list of PCIs relative to the set of PCIs), or an indication of the type(s) of the second information and how the second information is indicated, may be configured or predefined. In some examples, the PCI design may be configured according to an operator choice. For example, the network node 110 may configure the UE 120 with the PCI design by indicating the PCI design via broadcast or other connected-mode signaling. Additionally, or alternatively, in examples involving initial standalone access, the UE search may be reduced using assistance information, such as a PBCH hypothesis. In some examples, the configuration may be transmitted by a neighboring cell, such as a cell A or an anchor cell, via broadcast system information (SI) or RRC messages, or by the cell associated with the PCI via broadcast SI, MIB, or RRC messages. In some examples, the configuration information may be exchanged or negotiated over one or more network interfaces between two network nodes 110, the network node 110 and a core network, a DU of the network node 110 and a CU of the network node 110, or the like.

In some aspects, the subset of valid PCIs may be associated with one or more of a frequency, a frequency range, a frequency band, or an SCS. The subset of valid PCIs may be associated with one or more of the frequency, the frequency range, the frequency band, or the SCS in that the subset of valid PCIs may depend on one or more of the frequency, the frequency range, the frequency band, or the SCS. For example, the configuration or predefinition of the PCI design may depend on a frequency, frequency range (e.g., FR1 or FR2), a frequency band, or an SCS of the PCI(s).

In some aspects, the subset of valid PCIs may be associated with one or more of a tracking area or a period of time. The subset of valid PCIs may be associated with one or more of the tracking area or the period of time in that the subset of valid PCIs may depend on the tracking area or the period of time. For example, the (e.g., operator-specific) configuration or predefinition of the PCI design may be common or valid for all cells within the tracking area or the period of time (e.g., during peak or off-peak hours). For example, during off-peak hours, certain cells may shut down, which releases the corresponding PCIs; additionally, or alternatively, during peak hours, a quantity of mobile cells or user-based or neutral hosts may increase, which occupies more PCIs and can complicate PCI planning.

In some aspects, the subset of valid PCIs may be associated with a cell. The subset of valid PCIs may be associated with the cell in that the subset of valid PCIs may depend on the cell. For example, the (e.g., operator-specific) configuration or predefinition of the PCI design may be cell-specific. For example, the interpretation of the X most significant bits or the X least significant bits may depend on a value of the N-X other bits, or the interpretation of the second information carried by the SSS may depend on the PSS identifier.

In some aspects, the PCI may be associated with a random seed value. The random seed value may be a random or pseudorandom input to a function that generates an output based at least in part on the input. The PCI may be associated with the random seed value in that the PCI may be generated (e.g., by the function) using the random seed value as input. In some examples, PCI=f(random seed value, previous PCI value). In some examples, the random seed value may be carried in the MIB or other signaling. Additionally, or alternatively, the previous PCI value may be encoded by the SSB. PCIs generated using the random seed value in this manner may be referred to “hopping PCIs” because each PCI may be generated (e.g., “hop”) from a previous PCI. The PCI being associated with the random seed value may help to avoid persistent PCI collisions or conflicts.

In some aspects, one or more bits of the PCI that indicate information related to an identity of a cell may be associated with the random seed value. For example, the one or more bits may convey the first information discussed above. The one or more bits may be associated with the random seed value in that the one or more bits may be generated based at least in part on the random seed value (e.g., using the same function as discussed above or a different function). For example, the one or more bits may following random hopping procedures as discussed above.

In some aspects, the random seed value may be a selected random seed value of a plurality of candidate random seed values. The selected random seed value may be selected by the network node 110 (e.g., a cell) from among the plurality of candidate random seed values. The plurality of candidate random seed values may be a range of values. In some examples, the plurality of candidate random seed values may be predefined in a wireless communication standard or configured by the network node 110. In some examples, the UE 120 may, given the plurality of candidate random seed values, run multiple hypotheses to identify the selected random seed value.

In some aspects, the random seed value may be a first random seed value, and the network node 110 may transmit, and the UE 120 may receive, an indication of a second random seed value that is different than the first random seed value. For example, the network node 110 may indicate a change from the first random seed value to the second random seed value. The indication may be an SI update indication, a paging early indication (PEI), a paging PDCCH message, or a paging PDSCH message, among other examples. In some examples, the second random seed value may be a fixed PCI, and the indication may prompt the UE 120 to fall back to the fixed PCI.

In some aspects, the network node 110 may transmit, and the UE 120 may receive, a measurement or report configuration that includes an indication of the random seed value. The measurement or report configuration may be a set of instructions that specify how or when the UE 120 is to perform measurements or generate reports pertaining to network conditions, signal quality, or the like.

In some aspects, the UE 120 may transmit, and the network node 110 may receive, a report that includes an indication of the random seed value. Thus, in some examples, the network node 110 may acquire the random seed value from the UE 120. The report may be an MDT report, a mobility history report, a cell global identifier (CGI) report, or the like.

In some aspects, the PCI may be associated with the random seed value in accordance with one or more of a frequency, a frequency range, or a cell type. For example, the PCI may be generated based at least in part on the random seed value if the PCI corresponds to a cell of the frequency, the frequency range, or the cell type. The cell type may be a small cell type, a mobile cell type, a network energy savings (NES) cell type, an NTN cell type, or the like.

In some aspects, the network node 110 may transmit, and the UE 120 may receive, a random access communication that includes an indication of the random seed value. The random access communication may be a wireless communication that is transmitted as part of a random access procedure, such as a RACH procedure. For example, the random access communication may be a random access response (RAR).

In some aspects, the random seed value may be associated with information communicated via a network interface. The random seed value may be associated with the information in that the information may indicate a random seed value. The network interface may be an interface between two nodes of a network (e.g., between two network nodes 110, the network node 110 and a core network, a DU of the network node 110 and a CU of the network node 110, or the like). For example, the nodes may exchange or negotiate the information over the network interface and thereby choose the random seed value for a cell or a group of cells.

In some aspects, a length of time associated with a change of the random seed value may be predefined or configurable. The length of time may be associated with the change of the random seed value in that the length of time may control when the random seed value changes. For example, the length of time may indicate a frequency with which the PCI changes. For example, the PCI may change every MIB transmission time interval (TTI), every N MIB TTIs, every modification period, or the like. The length of time may be predefined in a wireless communication standard or configurable by the network node 110.

In some aspects, the network node 110 may transmit, and the UE 120 may receive, a tertiary synchronization signal (TSS). The TSS may be a signal that assists with synchronization to the network node 110. The TSS may serve as an additional synchronization signal to the PSS and the SSS. In some examples, the TSS may carry additional information. In some aspects, the TSS may indicate one or more of an information element (IE) or a PCI pool. For example, the TSS may carry emerging IEs or expanded PCI pools.

In some aspects, the TSS may be associated with one or more of a frequency, a frequency band, or an SCS. The TSS may be associated with one or more of the frequency, the frequency band, or the SCS in that a transmission of the TSS may depend on one or more of the frequency, the frequency band, or the SCS. For example, whether or not the TSS is transmitted may depend on the frequency, the frequency band, or the SCS.

In some aspects, the TSS may be associated with a tracking area. The TSS may be associated with the tracking area in that a transmission of the TSS may depend on the tracking area. For example, whether or not the TSS is transmitted may depend on the tracking area. Thus, whether or not the TSS is transmitted may be common across cells in the tracking area.

In some aspects, TSS may be associated with a cell type including one or more of a small cell type, an NTN cell type, a mobile cell type, a NES cell type, or an anchor cell type. The TSS may be associated with one or more of the small cell type, the NTN cell type, the mobile cell type, the NES cell type, or the anchor cell type in that a transmission of the TSS may depend on one or more of the small cell type, the NTN cell type, the mobile cell type, the NES cell type, or the anchor cell type. For example, whether or not the TSS is transmitted may depend on one or more of the small cell type, the NTN cell type, the mobile cell type, the NES cell type, or the anchor cell type. For example, whether or not the TSS is transmitted in call may depend on whether the cell is a small cell, an NTN cell, a mobile cell, an NES cell, an anchor cell, or the like.

In some aspects, a resource allocation of the TSS may be associated with one or more of a PSS, an SSS, or a DMRS. The resource allocation may be a set of time or frequency resources allocated for transmission of the TSS (e.g., with respect to one or more PSS or SSS resources. For example, the resource allocation may be one or more of a time domain resource allocation or a frequency domain resource allocation. The resource allocation may be associated with one or more of the PSS, the SSS, or the DMRS in that the resource allocation may be indicated by, or depend on, one or more of the PSS, the SSS, or the DMRS. For example, the resource allocation may be indicated by or depend on an identifier of the PSS, an identifier of the SSS, or the DMRS.

In some aspects, the resource allocation of the TSS may be associated with one or more of a frequency, a frequency band, or an SCS. The resource allocation may be associated with one or more of the frequency, the frequency band, or the SCS in that the resource allocation may be indicated by, or depend on, one or more of the frequency, the frequency band, or the SCS. In some aspects, the resource allocation of the TSS may be associated with a tracking area. The resource allocation may be associated with the tracking area in that the resource allocation may be indicated by, or depend on, the tracking area. For example, the resource allocation may be common across multiple cells within the tracking area. In some aspects, the resource allocation of the TSS may be associated with a cell type. The cell type may be a small cell type, an NTN cell type, a mobile cell type, an NES cell type, or an anchor cell type. The resource allocation may be associated with the cell type in that the resource allocation may be indicated by, or depend on, the cell type.

In some aspects, the network node 110 may transmit, and the UE 120 may receive, the TSS on-demand. The TSS may be transmitted or received on-demand in that the TSS may be transmitted or received in response to an uplink communication. For example, the network node 110 may transmit the TSS in response to receiving the uplink communication, such as an UL-WUS.

In some aspects, the TSS may be associated with a first length of time, and one or more of a PSS or an SSS may be associated with a second length of time that is less than the first length of time. The TSS may be associated with the first length of time in that the first length of time may control when the TSS is transmitted. For example, the first length of time may separate transmissions of the TSS in the time domain. The PSS or the SSS may be associated with the second length of time in that the second length of time may control when the PSS or the SSS is transmitted. The second length of time being less than the first length of time may cause the TSS to the transmitted less frequently than the one or more of the PSS or the SSS.

As shown by reference number 220, the network node 110 and the UE 120 may communicate one or more wireless communications in accordance with the PCI. For example, the one or more wireless communications may include one or more downlink wireless communications, and the network node 110 may transmit, and the UE 120 may receive, the one or more downlink wireless communications.

Additionally, or alternatively, the one or more wireless communications may include one or more uplink wireless communications, and the UE 120 may transmit, and the network node 110 may receive, the one or more uplink wireless communications. The network node 110 and the UE 120 may communicate the one or more wireless communications in accordance with the PCI in that the network node 110 and the UE 120 may communicate the one or more wireless communications in the cell or to enable access to the cell.

As indicated above, FIG. 2 is provided as an example. Other examples may differ from what is described with respect to FIG. 2.

FIG. 3 is a flowchart illustrating an example process 300 performed, for example, at a UE or an apparatus of a UE that supports PCI design. Example process 300 is an example where the apparatus or the UE (for example, UE 120) performs operations associated with PIC design.

As shown in FIG. 3, in some aspects, process 300 may include receiving an SSB that indicates a PCI of a subset of valid PCIs of a set of PCIs, the subset of valid PCIs corresponding to a cell search space that is reduced compared to a cell search space corresponding to the set of PCIs (block 310). For example, the UE (such as by using communication manager 150 or reception component 502, depicted in FIG. 5) may receive an SSB that indicates a PCI of a subset of valid PCIs of a set of PCIs, the subset of valid PCIs corresponding to a cell search space that is reduced compared to a cell search space corresponding to the set of PCIs, as described above.

As further shown in FIG. 3, in some aspects, process 300 may include communicating one or more wireless communications in accordance with the PCI (block 320). For example, the UE (such as by using communication manager 150, reception component 502, or transmission component 504, depicted in FIG. 5) may communicate one or more wireless communications in accordance with the PCI, as described above.

Process 300 may include additional or alternative aspects, such as any single aspect or any combination of aspects described below or in connection with one or more other processes described elsewhere herein.

In a first additional aspect, the subset of valid PCIs is associated with a single PSS.

In a second additional aspect, alone or in combination with the first aspect, the PCI is associated with first information related to an identity of a cell and second information that is different than the first information.

In a third additional aspect, alone or in combination with one or more of the first and second aspects, the second information is indicated by one or more most significant bits or one or more least significant bits of the PCI.

In a fourth additional aspect, alone or in combination with one or more of the first through third aspects, the second information is indicated by a PSS associated with the PCI.

In a fifth additional aspect, alone or in combination with one or more of the first through fourth aspects, the subset of valid PCIs is associated with one or more of a frequency, a frequency range, a frequency band, or an SCS.

In a sixth additional aspect, alone or in combination with one or more of the first through fifth aspects, the subset of valid PCIs is associated with one or more of a tracking area or a period of time.

In a seventh additional aspect, alone or in combination with one or more of the first through sixth aspects, the subset of valid PCIs is associated with a cell.

In an eighth additional aspect, alone or in combination with one or more of the first through seventh aspects, the PCI is associated with a random seed value.

In a ninth additional aspect, alone or in combination with one or more of the first through eighth aspects, one or more bits of the PCI that indicate information related to an identity of a cell are associated with the random seed value.

In a tenth additional aspect, alone or in combination with one or more of the first through ninth aspects, the random seed value is a selected random seed value of a plurality of candidate random seed values.

In an eleventh additional aspect, alone or in combination with one or more of the first through tenth aspects, the random seed value is a first random seed value, and process 300 includes receiving an indication of a second random seed value that is different than the first random seed value.

In a twelfth additional aspect, alone or in combination with one or more of the first through eleventh aspects, process 300 includes receiving a measurement or report configuration that includes an indication of the random seed value.

In a thirteenth additional aspect, alone or in combination with one or more of the first through twelfth aspects, process 300 includes transmitting a report that includes an indication of the random seed value.

In a fourteenth additional aspect, alone or in combination with one or more of the first through thirteenth aspects, the PCI is associated with the random seed value in accordance with one or more of a frequency, a frequency range, or a cell type.

In a fifteenth additional aspect, alone or in combination with one or more of the first through fourteenth aspects, process 300 includes receiving a random access communication that includes an indication of the random seed value.

In a sixteenth additional aspect, alone or in combination with one or more of the first through fifteenth aspects, the random seed value is associated with information communicated via a network interface.

In a seventeenth additional aspect, alone or in combination with one or more of the first through sixteenth aspects, a length of time associated with a change of the random seed value is predefined or configurable.

In an eighteenth additional aspect, alone or in combination with one or more of the first through seventeenth aspects, process 300 includes receiving a TSS.

In a nineteenth additional aspect, alone or in combination with one or more of the first through eighteenth aspects, the TSS is associated with one or more of a frequency, a frequency band, or an SCS.

In a twentieth additional aspect, alone or in combination with one or more of the first through nineteenth aspects, the TSS is associated with a tracking area.

In a twenty-first additional aspect, alone or in combination with one or more of the first through twentieth aspects, the TSS is associated with a cell type including one or more of a small cell type, a NTN cell type, a mobile cell type, a NES cell type, or an anchor cell type.

In a twenty-second additional aspect, alone or in combination with one or more of the first through twenty-first aspects, a resource allocation of the TSS is associated with one or more of a PSS, an SSS, or a DMRS.

In a twenty-third additional aspect, alone or in combination with one or more of the first through twenty-second aspects, a resource allocation of the TSS is associated with one or more of a frequency, a frequency band, or an SCS.

In a twenty-fourth additional aspect, alone or in combination with one or more of the first through twenty-third aspects, a resource allocation of the TSS is associated with a tracking area.

In a twenty-fifth additional aspect, alone or in combination with one or more of the first through twenty-fourth aspects, a resource allocation of the TSS is associated with a cell type.

In a twenty-sixth additional aspect, alone or in combination with one or more of the first through twenty-fifth aspects, receiving the TSS includes receiving the TSS on-demand.

In a twenty-seventh additional aspect, alone or in combination with one or more of the first through twenty-sixth aspects, the TSS is associated with a first length of time, and one or more of a PSS or an SSS are associated with a second length of time that is less than the first length of time.

In a twenty-eighth additional aspect, alone or in combination with one or more of the first through twenty-seventh aspects, the TSS indicates one or more of an IE or a PCI pool.

Although FIG. 3 shows example blocks of process 300, in some aspects, process 300 may include additional blocks, fewer blocks, different blocks, or differently arranged blocks than those depicted in FIG. 3. Additionally or alternatively, two or more of the blocks of process 300 may be performed in parallel.

FIG. 4 is a flowchart illustrating an example process 400 performed, for example, at a network node or an apparatus of a network node that supports PCI design. Example process 400 is an example where the apparatus or the network node (for example, network node 110) performs operations associated with PCI design.

As shown in FIG. 4, in some aspects, process 400 may include transmitting an SSB that indicates a PCI of a subset of valid PCIs of a set of PCIs, the subset of valid PCIs corresponding to a cell search space that is reduced compared to a cell search space corresponding to the set of PCIs (block 410). For example, the network node (such as by using communication manager 155 or transmission component 604, depicted in FIG. 6) may transmit an SSB that indicates a PCI of a subset of valid PCIs of a set of PCIs, the subset of valid PCIs corresponding to a cell search space that is reduced compared to a cell search space corresponding to the set of PCIs, as described above.

As further shown in FIG. 4, in some aspects, process 400 may include communicating one or more wireless communications in accordance with the PCI (block 420). For example, the network node (such as by using communication manager 155, reception component 602, or transmission component 604, depicted in FIG. 5) may communicate one or more wireless communications in accordance with the PCI, as described above.

Process 400 may include additional or alternative aspects, such as any single aspect or any combination of aspects described below or in connection with one or more other processes described elsewhere herein.

In a first additional aspect, the subset of valid PCIs is associated with a single PSS.

In a second additional aspect, alone or in combination with the first aspect, the PCI is associated with first information related to an identity of a cell and second information that is different than the first information.

In a third additional aspect, alone or in combination with one or more of the first and second aspects, the second information is indicated by one or more most significant bits or one or more least significant bits of the PCI.

In a fourth additional aspect, alone or in combination with one or more of the first through third aspects, the second information is indicated by a PSS associated with the PCI.

In a fifth additional aspect, alone or in combination with one or more of the first through fourth aspects, the subset of valid PCIs is associated with one or more of a frequency, a frequency range, a frequency band, or an SCS.

In a sixth additional aspect, alone or in combination with one or more of the first through fifth aspects, the subset of valid PCIs is associated with one or more of a tracking area or a period of time.

In a seventh additional aspect, alone or in combination with one or more of the first through sixth aspects, the subset of valid PCIs is associated with a cell.

In an eighth additional aspect, alone or in combination with one or more of the first through seventh aspects, the PCI is associated with a random seed value.

In a ninth additional aspect, alone or in combination with one or more of the first through eighth aspects, one or more bits of the PCI that indicate information related to an identity of a cell are associated with the random seed value.

In a tenth additional aspect, alone or in combination with one or more of the first through ninth aspects, the random seed value is a selected random seed value of a plurality of candidate random seed values.

In an eleventh additional aspect, alone or in combination with one or more of the first through tenth aspects, the random seed value is a first random seed value, and process 400 includes transmitting an indication of a second random seed value that is different than the first random seed value.

In a twelfth additional aspect, alone or in combination with one or more of the first through eleventh aspects, process 400 includes transmitting a measurement or report configuration that includes an indication of the random seed value.

In a thirteenth additional aspect, alone or in combination with one or more of the first through twelfth aspects, process 400 includes receiving a report that includes an indication of the random seed value.

In a fourteenth additional aspect, alone or in combination with one or more of the first through thirteenth aspects, the PCI is associated with the random seed value in accordance with one or more of a frequency, a frequency range, or a cell type.

In a fifteenth additional aspect, alone or in combination with one or more of the first through fourteenth aspects, process 400 includes transmitting a random access communication that includes an indication of the random seed value.

In a sixteenth additional aspect, alone or in combination with one or more of the first through fifteenth aspects, the random seed value is associated with information communicated via a network interface.

In a seventeenth additional aspect, alone or in combination with one or more of the first through sixteenth aspects, a length of time associated with a change of the random seed value is predefined or configurable.

In an eighteenth additional aspect, alone or in combination with one or more of the first through seventeenth aspects, process 400 includes transmitting a TSS.

In a nineteenth additional aspect, alone or in combination with one or more of the first through eighteenth aspects, the TSS is associated with one or more of a frequency, a frequency band, or an SCS.

In a twentieth additional aspect, alone or in combination with one or more of the first through nineteenth aspects, the TSS is associated with a tracking area.

In a twenty-first additional aspect, alone or in combination with one or more of the first through twentieth aspects, the TSS is associated with a cell type including one or more of a small cell type, a NTN cell type, a mobile cell type, a NES cell type, or an anchor cell type.

In a twenty-second additional aspect, alone or in combination with one or more of the first through twenty-first aspects, a resource allocation of the TSS is associated with one or more of a PSS, an SSS, or a DMRS.

In a twenty-third additional aspect, alone or in combination with one or more of the first through twenty-second aspects, a resource allocation of the TSS is associated with one or more of a frequency, a frequency band, or an SCS.

In a twenty-fourth additional aspect, alone or in combination with one or more of the first through twenty-third aspects, a resource allocation of the TSS is associated with a tracking area.

In a twenty-fifth additional aspect, alone or in combination with one or more of the first through twenty-fourth aspects, a resource allocation of the TSS is associated with a cell type.

In a twenty-sixth additional aspect, alone or in combination with one or more of the first through twenty-fifth aspects, transmitting the TSS includes transmitting the TSS on-demand.

In a twenty-seventh additional aspect, alone or in combination with one or more of the first through twenty-sixth aspects, the TSS is associated with a first length of time, and one or more of a PSS or an SSS are associated with a second length of time that is less than the first length of time.

In a twenty-eighth additional aspect, alone or in combination with one or more of the first through twenty-seventh aspects, the TSS indicates one or more of an IE or a PCI pool.

Although FIG. 4 shows example blocks of process 400, in some aspects, process 400 may include additional blocks, fewer blocks, different blocks, or differently arranged blocks than those depicted in FIG. 4. Additionally or alternatively, two or more of the blocks of process 400 may be performed in parallel.

FIG. 5 is a diagram of an example apparatus 500 for wireless communication that supports PCI design. The apparatus 500 may be a UE, or a UE may include the apparatus 500. In some aspects, the apparatus 500 includes a reception component 502, a transmission component 504, and a communication manager 506, which may be in communication with one another (for example, via one or more buses). As shown, the apparatus 500 may communicate with another apparatus 508 (such as a UE 120, a network node 110, or another wireless communication device) using the reception component 502 and the transmission component 504. The communication manager 506 may be included in, or implemented via, a processing system (for example, the processing system 140). In some aspects, the communication manager 506 is the communication manager 150.

In some aspects, the apparatus 500 may be configured to and/or operable to perform one or more operations described herein in connection with FIGS. 1-3. Additionally or alternatively, the apparatus 500 may be configured to and/or operable to perform one or more processes described herein, such as process 200 of FIG. 2.

The reception component 502 may receive communications, such as reference signals, control information, and/or data communications, from the apparatus 508. The reception component 502 may provide received communications to one or more other components of the apparatus 500, such as the communication manager 506. In some aspects, the reception component 502 may perform signal processing on the received communications, and may provide the processed signals to the one or more other components in a similar manner as described above in connection with FIG. 1. In some aspects, the reception component 502 may include one or more components of the UE described above in connection with FIG. 1, such as a radio, one or more RF chains, one or more transceivers, or one or more modems, each of which may in turn be coupled with one or more antennas of the UE.

The transmission component 504 may transmit communications, such as reference signals, control information, and/or data communications, to the apparatus 508. In some aspects, the communication manager 506 may generate communications and may transmit the generated communications to the transmission component 504 for transmission to the apparatus 508. In some aspects, the transmission component 504 may perform signal processing on the generated communications, and may transmit the processed signals to the apparatus 508 in a similar manner as described above in connection with FIG. 1. In some aspects, the transmission component 504 may include one or more components of the UE described above in connection with FIG. 1, such as a radio, one or more RF chains, one or more transceivers, or one or more modems, each of which may in turn be coupled with one or more antennas of the UE. In some aspects, the transmission component 504 may be co-located with the reception component 502.

The communication manager 506 may receive or may cause the reception component 502 to receive an SSB that indicates a PCI of a subset of valid PCIs of a set of PCIs, the subset of valid PCIs corresponding to a cell search space that is reduced compared to a cell search space corresponding to the set of PCIs. The communication manager 506 may communicate one or more wireless communications in accordance with the PCI. In some aspects, the communication manager 506 may perform one or more operations described elsewhere herein as being performed by one or more components of the communication manager 506.

The reception component 502 may receive an SSB that indicates a PCI of a subset of valid PCIs of a set of PCIs, the subset of valid PCIs corresponding to a cell search space that is reduced compared to a cell search space corresponding to the set of PCIs. The reception component 502 and/or the transmission component 504 may communicate one or more wireless communications in accordance with the PCI. In some aspects, the reception component 502 may receive a measurement or report configuration that includes an indication of the random seed value. In some aspects, the transmission component 504 may transmit a report that includes an indication of the random seed value. In some aspects, the reception component 502 may receive a random access communication that includes an indication of the random seed value. In some aspects, the reception component 502 may receive a TSS.

The quantity and arrangement of components shown in FIG. 5 are provided as an example. In practice, there may be additional components, fewer components, different components, or differently arranged components than those shown in FIG. 5. Furthermore, two or more components shown in FIG. 5 may be implemented within a single component, or a single component shown in FIG. 5 may be implemented as multiple, distributed components. Additionally or alternatively, a set of (one or more) components shown in FIG. 5 may perform one or more functions described as being performed by another set of components shown in FIG. 5.

FIG. 6 is a diagram of an example apparatus 600 for wireless communication that supports PCI design. The apparatus 600 may be a network node, or a network node may include the apparatus 600. In some aspects, the apparatus 600 includes a reception component 602, a transmission component 604, and a communication manager 606, which may be in communication with one another (for example, via one or more buses). As shown, the apparatus 600 may communicate with another apparatus 608 (such as a UE 120, a network node 110, or another wireless communication device) using the reception component 602 and the transmission component 604. The communication manager 606 may be included in, or implemented via, a processing system (for example, the processing system 145). In some aspects, the communication manager 606 is the communication manager 155.

In some aspects, the apparatus 600 may be configured to and/or operable to perform one or more operations described herein in connection with FIGS. 1-3. Additionally or alternatively, the apparatus 600 may be configured to and/or operable to perform one or more processes described herein, such as process 300 of FIG. 3.

The reception component 602 may receive communications, such as reference signals, control information, and/or data communications, from the apparatus 608. The reception component 602 may provide received communications to one or more other components of the apparatus 600, such as the communication manager 606. In some aspects, the reception component 602 may perform signal processing on the received communications, and may provide the processed signals to the one or more other components in a similar manner as described above in connection with FIG. 1. In some aspects, the reception component 602 may include one or more components of the network node described above in connection with FIG. 1, such as a radio, one or more RF chains, one or more transceivers, or one or more modems, each of which may in turn be coupled with one or more antennas of the network node.

The transmission component 604 may transmit communications, such as reference signals, control information, and/or data communications, to the apparatus 608. In some aspects, the communication manager 606 may generate communications and may transmit the generated communications to the transmission component 604 for transmission to the apparatus 608. In some aspects, the transmission component 604 may perform signal processing on the generated communications, and may transmit the processed signals to the apparatus 608 in a similar manner as described above in connection with FIG. 1. In some aspects, the transmission component 604 may include one or more components of the network node described above in connection with FIG. 1, such as a radio, one or more RF chains, one or more transceivers, or one or more modems, each of which may in turn be coupled with one or more antennas of the network node. In some aspects, the transmission component 604 may be co-located with the reception component 602.

The communication manager 606 may transmit or may cause the transmission component 604 to transmit an SSB that indicates a PCI of a subset of valid PCIs of a set of PCIs, the subset of valid PCIs corresponding to a cell search space that is reduced compared to a cell search space corresponding to the set of PCIs. The communication manager 606 may communicate one or more wireless communications in accordance with the PCI. In some aspects, the communication manager 606 may perform one or more operations described elsewhere herein as being performed by one or more components of the communication manager 606.

The transmission component 604 may transmit an SSB that indicates a PCI of a subset of valid PCIs of a set of PCIs, the subset of valid PCIs corresponding to a cell search space that is reduced compared to a cell search space corresponding to the set of PCIs. The reception component 602 and/or the transmission component 604 may communicate one or more wireless communications in accordance with the PCI. In some aspects, the transmission component 604 may transmit a measurement or report configuration that includes an indication of the random seed value. In some aspects, the reception component 602 may receive a report that includes an indication of the random seed value. In some aspects, the transmission component 604 may transmit a random access communication that includes an indication of the random seed value. In some aspects, the transmission component 604 may transmit a TSS.

The quantity and arrangement of components shown in FIG. 6 are provided as an example. In practice, there may be additional components, fewer components, different components, or differently arranged components than those shown in FIG. 6. Furthermore, two or more components shown in FIG. 6 may be implemented within a single component, or a single component shown in FIG. 6 may be implemented as multiple, distributed components. Additionally or alternatively, a set of (one or more) components shown in FIG. 6 may perform one or more functions described as being performed by another set of components shown in FIG. 6.

The following provides an overview of some Aspects of the present disclosure:

Aspect 1: A method of wireless communication performed at a user equipment (UE), comprising: receiving a synchronization signal block (SSB) that indicates a physical cell identity (PCI) of a subset of valid PCIs of a set of PCIs, the subset of valid PCIs corresponding to a cell search space that is reduced compared to a cell search space corresponding to the set of PCIs; and communicating one or more wireless communications in accordance with the PCI.

Aspect 2: The method of Aspect 1, wherein the subset of valid PCIs is associated with a single primary synchronization signal (PSS).

Aspect 3: The method of any of Aspects 1-2, wherein the PCI is associated with first information related to an identity of a cell and second information that is different than the first information.

Aspect 4: The method of Aspect 3, wherein the second information is indicated by one or more most significant bits or one or more least significant bits of the PCI.

Aspect 5: The method of Aspect 3, wherein the second information is indicated by a primary synchronization signal (PSS) associated with the PCI.

Aspect 6: The method of any of Aspects 1-5, wherein the subset of valid PCIs is associated with one or more of a frequency, a frequency range, a frequency band, or a subcarrier spacing (SCS).

Aspect 7: The method of any of Aspects 1-6, wherein the subset of valid PCIs is associated with one or more of a tracking area or a period of time.

Aspect 8: The method of any of Aspects 1-7, wherein the subset of valid PCIs is associated with a cell.

Aspect 9: The method of any of Aspects 1-8, wherein the PCI is associated with a random seed value.

Aspect 10: The method of Aspect 9, wherein one or more bits of the PCI that indicate information related to an identity of a cell are associated with the random seed value.

Aspect 11: The method of Aspect 9, wherein the random seed value is a selected random seed value of a plurality of candidate random seed values.

Aspect 12: The method of Aspect 9, wherein the random seed value is a first random seed value, the method further comprising: receiving an indication of a second random seed value that is different than the first random seed value.

Aspect 13: The method of Aspect 9, further comprising: receiving a measurement or report configuration that includes an indication of the random seed value.

Aspect 14: The method of Aspect 9, further comprising: transmitting a report that includes an indication of the random seed value.

Aspect 15: The method of Aspect 9, wherein the PCI is associated with the random seed value in accordance with one or more of a frequency, a frequency range, or a cell type.

Aspect 16: The method of Aspect 9, further comprising: receiving a random access communication that includes an indication of the random seed value.

Aspect 17: The method of Aspect 9, wherein the random seed value is associated with information communicated via a network interface.

Aspect 18: The method of Aspect 9, wherein a length of time associated with a change of the random seed value is predefined or configurable.

Aspect 19: The method of any of Aspects 1-18, further comprising: receiving a tertiary synchronization signal (TSS).

Aspect 20: The method of Aspect 19, wherein the TSS is associated with one or more of a frequency, a frequency band, or a subcarrier spacing (SCS).

Aspect 21: The method of Aspect 19, wherein the TSS is associated with a tracking area.

Aspect 22: The method of Aspect 19, wherein the TSS is associated with a cell type including one or more of a small cell type, a NTN cell type, a mobile cell type, a NES cell type, or an anchor cell type.

Aspect 23: The method of Aspect 19, wherein a resource allocation of the TSS is associated with one or more of a primary synchronization signal (PSS), a secondary synchronization signal (SSS), or a demodulation reference signal (DMRS).

Aspect 24: The method of Aspect 19, wherein a resource allocation of the TSS is associated with one or more of a frequency, a frequency band, or a subcarrier spacing (SCS).

Aspect 25: The method of Aspect 19, wherein a resource allocation of the TSS is associated with a tracking area.

Aspect 26: The method of Aspect 19, wherein a resource allocation of the TSS is associated with a cell type.

Aspect 27: The method of Aspect 19, wherein receiving the TSS includes receiving the TSS on-demand.

Aspect 28: The method of Aspect 19, wherein the TSS is associated with a first length of time, and one or more of a primary synchronization signal (PSS) or a secondary synchronization signal (SSS) are associated with a second length of time that is less than the first length of time.

Aspect 29: A method of wireless communication performed at a network node, comprising: transmitting a synchronization signal block (SSB) that indicates a physical cell identity (PCI) of a subset of valid PCIs of a set of PCIs, the subset of valid PCIs corresponding to a cell search space that is reduced compared to a cell search space corresponding to the set of PCIs; and communicating one or more wireless communications in accordance with the PCI.

Aspect 30: The method of Aspect 29, wherein the subset of valid PCIs is associated with a single primary synchronization signal (PSS).

Aspect 31: The method of any of Aspects 29-30, wherein the PCI is associated with first information related to an identity of a cell and second information that is different than the first information.

Aspect 32: The method of Aspect 31, wherein the second information is indicated by one or more most significant bits or one or more least significant bits of the PCI.

Aspect 33: The method of Aspect 31, wherein the second information is indicated by a primary synchronization signal (PSS) associated with the PCI.

Aspect 34: The method of any of Aspects 29-33, wherein the subset of valid PCIs is associated with one or more of a frequency, a frequency range, a frequency band, or a subcarrier spacing (SCS).

Aspect 35: The method of any of Aspects 29-34, wherein the subset of valid PCIs is associated with one or more of a tracking area or a period of time.

Aspect 36: The method of any of Aspects 29-35, wherein the subset of valid PCIs is associated with a cell.

Aspect 37: The method of any of Aspects 29-36, wherein the PCI is associated with a random seed value.

Aspect 38: The method of Aspect 37, wherein one or more bits of the PCI that indicate information related to an identity of a cell are associated with the random seed value.

Aspect 39: The method of Aspect 37, wherein the random seed value is a selected random seed value of a plurality of candidate random seed values.

Aspect 40: The method of Aspect 37, wherein the random seed value is a first random seed value, the method further comprising: transmitting an indication of a second random seed value that is different than the first random seed value.

Aspect 41: The method of Aspect 37, further comprising: transmitting a measurement or report configuration that includes an indication of the random seed value.

Aspect 42: The method of Aspect 37, further comprising: receiving a report that includes an indication of the random seed value.

Aspect 43: The method of Aspect 37, wherein the PCI is associated with the random seed value in accordance with one or more of a frequency, a frequency range, or a cell type.

Aspect 44: The method of Aspect 37, further comprising: transmitting a random access communication that includes an indication of the random seed value.

Aspect 45: The method of Aspect 37, wherein the random seed value is associated with information communicated via a network interface.

Aspect 46: The method of Aspect 37, wherein a length of time associated with a change of the random seed value is predefined or configurable.

Aspect 47: The method of any of Aspects 29-46, further comprising: transmitting a tertiary synchronization signal (TSS).

Aspect 48: The method of Aspect 47, wherein the TSS is associated with one or more of a frequency, a frequency band, or a subcarrier spacing (SCS).

Aspect 49: The method of Aspect 47, wherein the TSS is associated with a tracking area.

Aspect 50: The method of Aspect 47, wherein the TSS is associated with a cell type including one or more of a small cell type, a NTN cell type, a mobile cell type, a NES cell type, or an anchor cell type.

Aspect 51: The method of Aspect 47, wherein a resource allocation of the TSS is associated with one or more of a primary synchronization signal (PSS), a secondary synchronization signal (SSS), or a demodulation reference signal (DMRS).

Aspect 52: The method of Aspect 47, wherein a resource allocation of the TSS is associated with one or more of a frequency, a frequency band, or a subcarrier spacing (SCS).

Aspect 53: The method of Aspect 47, wherein a resource allocation of the TSS is associated with a tracking area.

Aspect 54: The method of Aspect 47, wherein a resource allocation of the TSS is associated with a cell type.

Aspect 55: The method of Aspect 47, wherein transmitting the TSS includes transmitting the TSS on-demand.

Aspect 56: The method of Aspect 47, wherein the TSS is associated with a first length of time, and one or more of a primary synchronization signal (PSS) or a secondary synchronization signal (SSS) are associated with a second length of time that is less than the first length of time.

Aspect 57: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-56, 64, or 65.

Aspect 58: An apparatus for wireless communication at a device, the apparatus comprising one or more memories and one or more processors coupled to the one or more memories, the one or more processors configured to cause the device to perform the method of one or more of Aspects 1-56, 64, or 65.

Aspect 59: An apparatus for wireless communication, the apparatus comprising at least one means for performing the method of one or more of Aspects 1-56, 64, or 65.

Aspect 60: A non-transitory computer-readable medium storing code for wireless communication, the code comprising instructions executable by one or more processors to perform the method of one or more of Aspects 1-56, 64, or 65.

Aspect 61: A non-transitory computer-readable medium storing a set of instructions for wireless communication, the set of instructions comprising one or more instructions that, when executed by one or more processors of a device, cause the device to perform the method of one or more of Aspects 1-56, 64, or 65.

Aspect 62: A device for wireless communication, the device comprising a processing system that includes one or more processors and one or more memories coupled with the one or more processors, the processing system configured to cause the device to perform the method of one or more of Aspects 1-56, 64, or 65.

Aspect 63: An apparatus for wireless communication at a device, the apparatus comprising one or more memories and one or more processors coupled to the one or more memories, the one or more processors individually or collectively configured to cause the device to perform the method of one or more of Aspects 1-56, 64, or 65.

Aspect 64: The method of Aspect 19, wherein the TSS indicates one or more of an IE or a PCI pool.

Aspect 65: The method of Aspect 47, wherein the TSS indicates one or more of an IE or a PCI pool.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories storing processor-executable code; and
one or more processors coupled with the one or more memories, at least one processor of the one or more processors configured to cause the UE to:
receive a synchronization signal block (SSB) that indicates a physical cell identity (PCI) of a subset of valid PCIs of a set of PCIs, the subset of valid PCIs corresponding to a cell search space that is reduced compared to a cell search space corresponding to the set of PCIs; and
communicate one or more wireless communications in accordance with the PCI.

2. The apparatus of claim 1, wherein the subset of valid PCIs is associated with a single primary synchronization signal (PSS).

3. The apparatus of claim 1, wherein the PCI is associated with first information related to an identity of a cell and second information that is different than the first information.

4. The apparatus of claim 3, wherein the second information is indicated by one or more most significant bits or one or more least significant bits of the PCI.

5. The apparatus of claim 3, wherein the second information is indicated by a primary synchronization signal (PSS) associated with the PCI.

6. The apparatus of claim 1, wherein the subset of valid PCIs is associated with one or more of a frequency, a frequency range, a frequency band, or a subcarrier spacing (SCS).

7. The apparatus of claim 1, wherein the subset of valid PCIs is associated with one or more of a tracking area or a period of time.

8. The apparatus of claim 1, wherein the subset of valid PCIs is associated with a cell.

9. The apparatus of claim 1, wherein the PCI is associated with a random seed value.

10. The apparatus of claim 9, wherein one or more bits of the PCI that indicate information related to an identity of a cell are associated with the random seed value.

11. The apparatus of claim 9, wherein the random seed value is a selected random seed value of a plurality of candidate random seed values.

12. The apparatus of claim 9, wherein the random seed value is a first random seed value, and wherein at least one processor of the one or more processors is configured to cause the UE to:
receive an indication of a second random seed value that is different than the first random seed value.

13. The apparatus of claim 9, wherein at least one processor of the one or more processors is configured to cause the UE to:
receive a measurement or report configuration that includes an indication of the random seed value.

14. The apparatus of claim 9, wherein at least one processor of the one or more processors is configured to cause the UE to:
transmit a report that includes an indication of the random seed value.

15. The apparatus of claim 9, wherein the PCI is associated with the random seed value in accordance with one or more of a frequency, a frequency range, or a cell type.

16. The apparatus of claim 9, wherein at least one processor of the one or more processors is configured to cause the UE to:
receive a random access communication that includes an indication of the random seed value.

17. The apparatus of claim 9, wherein the random seed value is associated with information communicated via a network interface.

18. The apparatus of claim 9, wherein a length of time associated with a change of the random seed value is predefined or configurable.

19. A method of wireless communication performed at a user equipment (UE), comprising:
receiving a synchronization signal block (SSB) that indicates a physical cell identity (PCI) of a subset of valid PCIs of a set of PCIs, the subset of valid PCIs corresponding to a cell search space that is reduced compared to a cell search space corresponding to the set of PCIs; and
communicating one or more wireless communications in accordance with the PCI.

20. An apparatus for wireless communication, comprising:
means for receiving a synchronization signal block (SSB) that indicates a physical cell identity (PCI) of a subset of valid PCIs of a set of PCIs, the subset of valid PCIs corresponding to a cell search space that is reduced compared to a cell search space corresponding to the set of PCIs; and
means for communicating one or more wireless communications in accordance with the PCI.
